(19) United States
(12) Patent Application Publication
(10) Pub. No.: US 2024/0185264 A1
(43) Pub. Date: Jun. 6, 2024

(54) SYSTEM AND METHOD FOR ENHANCING CONTRACTOR SERVICES TO POTENTIAL CUSTOMERS

(71) Applicants: Michael Mastapeter, Melbourne, FL (US); Phyllis Mastapeter, West Long Beach, NJ (US); Jennifer Fornarotto, Allenwood, NJ (US)

(72) Inventors: Michael Mastapeter, Melbourne, FL (US); Phyllis Mastapeter, West Long Beach, NJ (US); Jennifer Fornarotto, Allenwood, NJ (US)

(21) Appl. No.: 18/073,727

(22) Filed: Dec. 2, 2022

(51) Int. Cl. G06Q 30/0201; G06F 21/31

(52) U.S. Cl. CPC G06Q 30/0201; G06F 21/31

(57) ABSTRACT

An intelligence gathering method for contractors on a potential customer comprises accessing, by a computing device, a database server configured to store customer data of a plurality of customers as provided by a plurality of contractors, through a dedicated web interface provided on the computing device. The customer data includes information of at least one contractor service provided by a contractor to at least one customer, details of the customer, location of the service given, scope of the service, and a rating of the customer given by the contractor. Customer data is accessed by creating a contractor account using at least one personal detail of the contractor, authenticating the contractor account, and verifying the contractor account. Verification is effected by evaluating authenticity of verification information provided by the contractor. A customer evaluation query is received and information on the potential customer is displayed.

### FIELD OF INVENTION

The present invention relates to consumer contractor connector apparatuses, methods and systems for connecting contractors and consumers with respect to one or more projects, work orders, jobs or the like; and, more particularly, addresses bridging of gaps between contractors and customers by applications, systems and methods that connect contractors with potential customers in an insightful manner.

### DESCRIPTION OF THE PRIOR ART

Customers demand more of the products and services they use than ever before. They insist that the companies they deal with on a regular basis provide them with greater levels of accuracy and more tailored service offerings, which is their right to ask. Thus there is a need for an application, system and/or method that provides home improvement contractors and other professionals with a verified review source so that they can better understand how to best serve potential clients based on contractors' knowledge of contractor services, the client's shopping habits, and ease of satisfaction.

### SUMMARY OF THE INVENTION

This section provides a general summary of the disclosure, and is not a comprehensive disclosure of its full scope of all its features.

The present invention provides an intelligence-gathering method for contractors on a potential customer. A database server is configured to store customer data of a plurality of customers, as provided by a plurality of contractors, through a dedicated web interface provided on the computing device. The customer data includes information regarding at least one contractor service provided by a contractor to at least one customer, details regarding the customer, location of the service given, scope of the service, and a rating of the customer provided by the contractor. A contractor account is created using at least one personal detail of the contractor. The contractor account is authenticated using email authentication and mobile based authentication, and verified using at least one verification information provided by the contractor of a project under process or completed by the contractor. The verifying step comprises evaluating the authenticity of the verification information provided by the contractor and verifying the contractor based on authentication of the verification information by receiving, using the computing device, a customer evaluation query for at least one potential customer from the contactor. Information regarding the at least one customer is displayed displaying through the computing device to gain insights on the customer.

In another embodiment, the method includes creating a record of a new customer for evaluation by the one or more verified contractors.

In an embodiment of the present invention, the verifying contractor account comprises uploading images of documents such as initial contract and certificate of project completion.

In an embodiment of the present invention, the uploaded images are configured to digitally signed document and e-stamp documents.

In an embodiment, the authenticating includes sending one email authentication time-bound code and a mobile authentication time-bound code via two separate communication channels and authenticating based on the same.

In an embodiment of the present invention, the method includes evaluating one or more selection criteria to find the best customers for more seamless experiences.

In another embodiment of the present invention, the one or more selection criteria about customers is based on the contractor's field of expertise and one or more contractors' working experiences with the customers.

Significant advantages are incorporated by the elements of the present invention. Every day, field experts such as General Contractors, share qualified reviews and experiences with the homeowners they serve to help other home service providers find the best homeowners for more seamless experiences based on the following key criteria: (i) How versed is the homeowner in the Contractor's field of expertise?; (ii) How was the Contractor's experience working with the homeowner?; (iii) Would the Contractor work with the customer again?; (iv) Is the homeowner a price shopper?

The Contractor can use this real-time, trusted information to gain better insights about potential customers and set himself up for success before every sales call. The Contractor can review the current homeowners he works with and read reviews about prospective homeowners that the Contractor considers working with to decide whether in each instance the Contractor and the homeowner are both a right fit for a working relationship.

### BRIEF DESCRIPTION OF THE DRAWINGS

The invention will be more fully understood and further advantages will become apparent when reference is had to the following detailed description and the accompanying drawings, in which:

FIG. 1 illustrates a block diagram of the contractor device, in accordance with an embodiment of the present invention;

FIG. 2 illustrates a flow chart representation of an intelligence gathering method, in accordance with an embodiment of the present invention.

FIG. 3 illustrates the flow chart representation of an authentication step of the intelligent gathering method, in accordance with the embodiment of the present invention.

FIG. 4 illustrates the flow chart representation of a verification step of the intelligent gathering method, in accordance with the embodiment of the present invention.

### DETAILED DESCRIPTION OF THE INVENTION

The embodiments herein and the various features and advantageous details thereof are explained more fully with reference to the non-limiting embodiments that are illustrated in the accompanying drawings and the following description. Numerous variation, changes and substitution may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition as persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the invention, as defined by the subjoined claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

Computing device/servers as shown may include processors, memory, interfaces, electronic circuitry and modules/engines implemented by hardware-cum-software components to carry out one or more functions and/or applications, such as a client application running on the user device. The one or more modules/engines may carry out various computing instructions and/or control operations stored on the memory through the processors.

The present invention is directed to applications, systems and methods to provide home improvement contractors and other professionals with a verified review source so that the contractors may better understand how to best serve potential clients/homeowners based on the Contractors' knowledge of contractor services, shopping habits, and ease of satisfaction. The invention provides a rating system that creates transparency between homeowners and contractors/professionals so that everyone involved in a transaction may enjoy a hassle-free end-to-end experience. It also helps the professionals/contractor to avoid entering into contracts with clients known to be challenging to work with, freeing the contractor of unrealistic expectations, impractical demands, and potentially getting “stiffed” on the contractor's work.

The system as disclosed herein below makes use of the information shared every day by field experts, just like general contractors, in the form of qualified reviews and experiences with the homeowners they serve, to help other home service providers find the best homeowners for more seamless experiences based on four key criteria:
a) How versed is the homeowner in the Contractor's field of expertise?
b) How was the Contractor's experience working with the homeowner?
c) Would the Contractor work with the customer again?
d) Is the homeowner a price shopper?

The system allows new and existing contractors to have access to the system, use this real-time, trusted information to gain better insights about potential customers and set themselves up for success before every sales call. A contractor, for example, may review the current homeowners he/she works with and read reviews about prospective homeowners that the contractor considers working with to decide whether in each instance the contractor and the homeowner are both a right fit for a working relationship. The present system helps contractors to avoid entering into contracts with clients known to be challenging to work with and, in doing so, frees the contractors of unrealistic expectations, impractical demands, and potentially getting “stiffed” on the contractor's work.

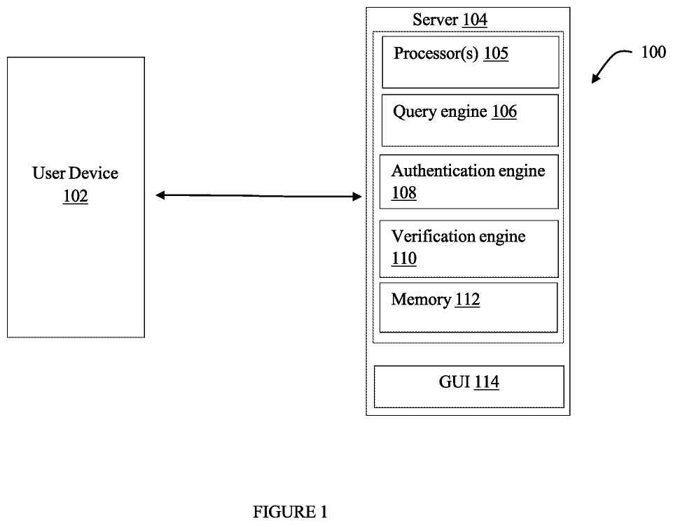

FIG. 1 illustrates a block diagram of an exemplary network architecture 100 for implementing a system for connecting contractors with potential customers in a knowledgeable manner. The system may be incorporated in the form of a database server, for example, server 104, which can be accessed by one or more contractors through their respective user devices 102 over a network. The user device 102 may include computing devices such a smartphone, laptops, computers and so on.

In an embodiment, the user device 102 is capable of accessing server 104 through a web link or URL. The server 104 configuration is such that it provides scalability to support requests from many user devices simultaneously.

The network can be any type of wired and/or wireless public or private network including a cellular network, a local area network, a wide area network such as the Internet or the World Wide Web (WWW), a personal area network, etc. Network further may comprise sub-networks and consists of any number and types of communication networking devices. Illustrative communication networking devices include a firewall, a proxy server, a router, a multilayer switch, a modem, and the like.

The user device 102 may also access server 104 through a mobile based application configured in the user device 102 to access server 104 through a web interface. The server 104 may include processing circuitry including one or more processors 105, memory 112 and various modules/engines that make the processors to carry out various instructions/control actions stored in the memory. In an embodiment, the homeowner's working experience with a contractor, along with the contractor rating of the customer, is stored in memory 112.

The memory 112 may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware). Memory 112 is used for storing data and instructions suitable for controlling the operation of the processor(s).

The various engines/modules that are part of the server 104, in an embodiment, include a query engine 106, an authentication engine 108 and a verification engine 110. Further, there includes a graphical user interface (GUI) 114 through which inputs and other data is received by the server 104.

In an operational embodiment, server 104 receives an access request from a contractor or a user via a user device 102 configured to access server 104 through a web interface or a mobile application. Server 104 allows access only to authenticated and verified users and for that, the server responds to the access request by allowing the user to first authenticate itself, through email or mobile-based authentication process, and then verifying the authentication details of the contractor received as input. In an embodiment, authentication involves sending one email authentication time-bound code and a mobile authentication time-bound code to the contractor device 102 via two separate communication channels, for example, one through the web and the other through short message service for respective authentication, and authenticating based on the same. Upon authentication and verification, the user may input a customer evaluation query for at least one potential customer and details including a review of the customer are displayed on a display device of the user device 102.

In an embodiment, the server 104 receives inputs from the user via the graphical user interface 114, which is then processed by the various engines (106, 108, 110) in conjunction with the processor(s) 105 to allow the contractor to access the server 104. create an account, verify it and then search for potential customers and their ratings. The user interface 114 allows communication between the various components of the server 104 in addition to allowing the user device 102 to access the server 104.

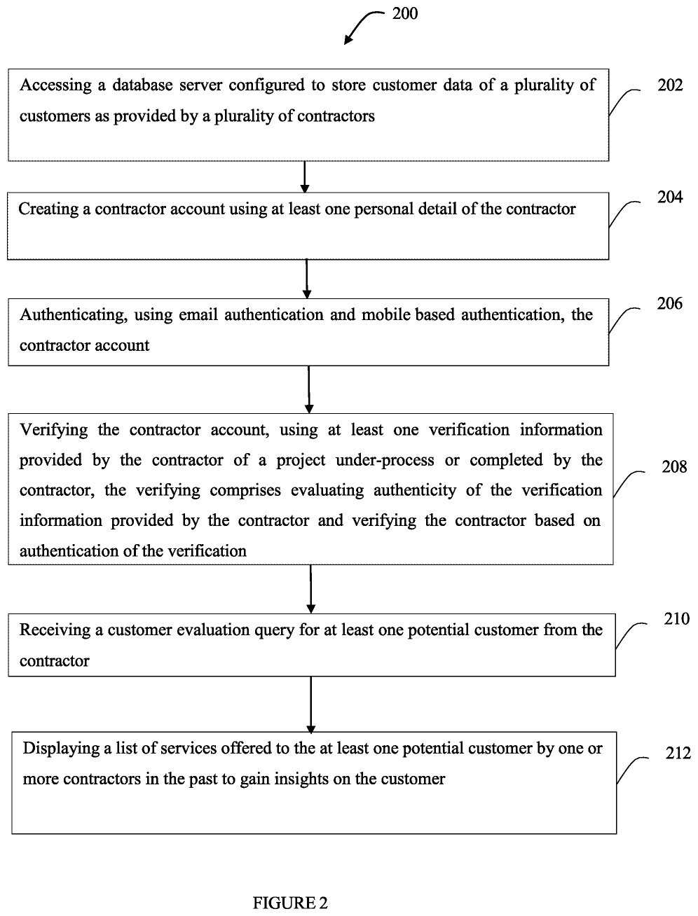

FIG. 2 illustrates a flow diagram of an intelligence gathering method 200 for contractors on a potential customer in accordance with a preferred embodiment of the invention. The intelligence gathering method 200 for contractors will be described with respect to the flow diagram. The intelligence gathered by the contractors may include homeowner's data including their behaviors, work experience with other contractors, shopping patterns, and the like.

As illustrated in FIG. 2, the method includes at step 202 accessing, by a computing device 102, a database server 104 configured to store customer data of a plurality of customers as provided by a plurality of contractors, through a dedicated web interface provided on the computing device. The customer data includes information of at least one contractor service provided by a contractor to one or more customers, details of the customer, location of the service given, scope of the service, and a rating of the customer given by the contractor.

In step 204, a contractor account is created or accessed using at least one personal detail of the contractor through, for example, a mobile-based web interface. In step 206, the contractor account is authenticated, for example, through email and mobile-based authentication. Further, in step 208, the contractor account is verified using at least one verification information provided by the contractor of a project under process or completed by the contractor. The verification includes evaluating the authentication of the verification information provided by the contractor and verifying the contractor based on the authentication of the verification information. For example, the verification of the contractor account may include verification of data provided in the form of documents/images uploaded by the contractor such as e-verified or e-signed contract documents or a certificate of project completion. The documents for verification may include a government document verifying identity of the contractor, past/present contracts secured by the contractor such as digitally signed agreements and executed e-stamp documents.

In step 210, a customer evaluation query for at least one potential customer from the contactor is received. The customer evaluation query would fetch details of the customer including customer working experience information with other contractors. For a new customer with no past details, a new record would be created for updating by existing verified contractors. In an embodiment, for a customer having records already existing in the server, the evaluation of the customer is based on the following criteria:
How versed is the homeowner in the Contractor's field of expertise?
How was the Contractor's experience working with the homeowner?
Would the Contractor work with the customer again?
Is the homeowner a price shopper?

In step 212, the information is then displayed on the user device of the contractor from which he/she can gain useful insights about the customer.

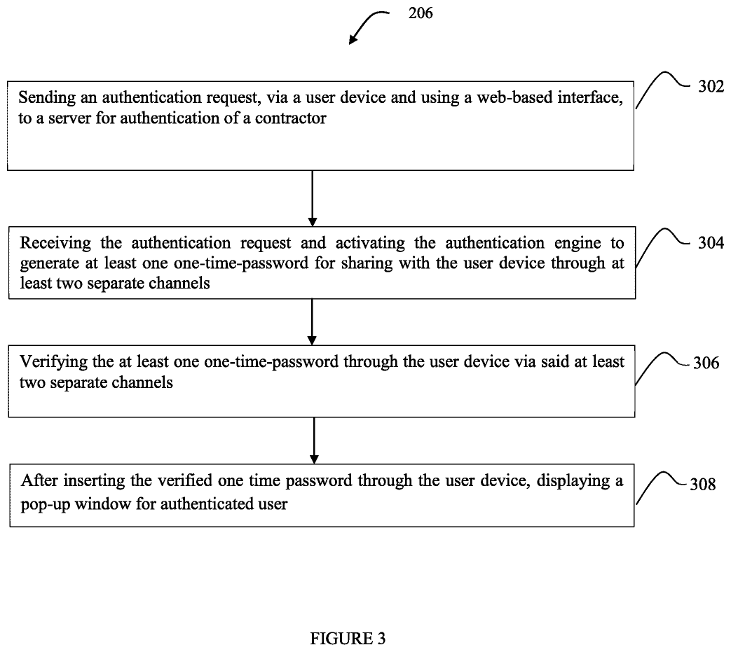

FIG. 3 illustrates a flow diagram of the authentication step 206 of the intelligence gathering method for contractors in accordance with the preferred embodiment. The authentication step may include password or pin-based authentication via two or more communication channels such as email, SMS and the like. In step 302, an authentication request is sent to the server for authentication of a contractor via a user device following the creating step, as shown in FIG. 2. In step 304, the authentication request is received by the server. The authentication engine 108 in response to receiving the authentication request generates a time-bound one-time password and shares the same with the user device through two distinct channels including over an email and through a short message service. In step 306, the contractor through the user device validates and authenticates the one-time password (OTP) by inputting the OTP as received from the server, in step 308, thus authenticating the contractor as a genuine user.

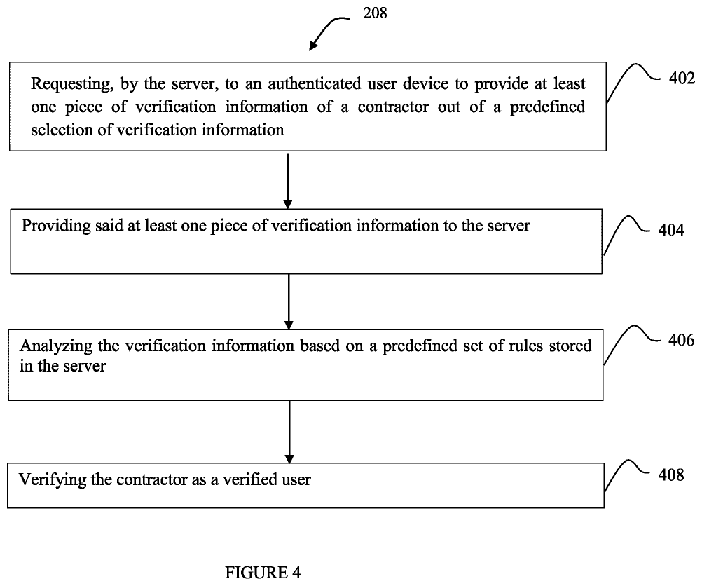

FIG. 4 illustrates a flow diagram of the verification step 208 of the intelligence gathering method for contractors which, in accordance with the preferred embodiment, will be described with respect to the flow diagram.

In step 402, the server may send a request to an authenticated user device to upload verification information by an authenticated contractor. The verification information may include but is not limited to contractor-homeowner contract, completion of a service, memorandum of understanding and the like. The verification information may be selected from a predefined list of verification information accepted by server 104 for verification purposes. The verification information in the form of physical documents may be uploaded by the contractor through the user device, in step 404, is scanned at server 104 utilizing, for example, a document scanning application or OCR technique for predefined attributes such as for originality, authorized signatory, notarization and the like. For example, the verification-related document is a soft copy document, the content of which may be read by reading various document metadata and/or document content, wherein the document content may also be recognized using OCR or alternatively retrieved from an appropriate database, such as the database of a verification server (not shown).

The set of rules related to the verification information is pre-stored in the database server. The set of rules may include verification steps for digitally signed documents, original contract documents and copied documents. In step 406, the verification information is analyzed based on the predefined set of rules.

In step 408, after analyzing the verification information, the contractor is verified and a message is displayed on the user device acknowledging the same.

The present invention provides a technical solution to a technical problem pertaining to accessing insights on a potential customer that may not be verifiable in existing platforms. Further, only authenticated and verified contractors may access the system and the contractor's feedback is also verified.

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An intelligence gathering method for contractors on a potential customer, the method comprising:
accessing, by a computing device, a database server configured to store customer data of a plurality of customers as provided by a plurality of contractors, through a dedicated web interface provided on the computing device, the customer data including information of at least one contractor service provided by a contractor to at least one customer, details of the customer, location of the service given, scope of the service, and a rating of the customer given by the contractor, wherein the accessing comprises:
creating, using a computing device, a contractor account using at least one personal detail of the contractor;
authenticating, using email authentication and mobile-based authentication, the contractor account;
verifying the contractor account, using at least one verification information provided by the contractor of a project under process or completed by the contractor, wherein the verifying comprises evaluating authenticity of the verification information provided by the contractor and verifying the contractor based on authentication of the verification information;
receiving, using the computing device, a customer evaluation query for at least one potential customer from the contactor; and
displaying, through the computing device, information of the at least one potential customer to gain insights on the customer.

2. The method of claim 1 further comprising creating a record of a new customer for evaluation by the one or more verified contractors.

3. The method of claim 1, wherein the verifying contractor account comprises uploading images of documents such as initial contract and certificate of project completion.

4. The method of claim 1, wherein the uploaded images configured to digitally signed document and e-stamp documents.

5. The method of claim 1, wherein the authenticating comprises sending one email authentication time-bound code and a mobile authentication time-bound code via two separate communication channels and authenticating based on the same.

6. The method of claim 1, further comprising, evaluating one or more selection criteria to find the best customers for more seamless experiences.

7. The method of claim 1, wherein the one or more selection criteria about customers is based on contractor's field of expertise and one or more contractor's working experiences with the customers.
